(19) United States
(12) Patent Application Publication
(10) Pub. No.: US 2003/0089668 A1
(43) Pub. Date: May 15, 2003

(54) Phosphorus reduction in aqueous streams

(76) Inventor: Robert Harvey Moffett, Landenberg, PA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 09/898,437

(22) Filed: Jul. 3, 2001

(51) Int. Cl. C02F 1/52

(52) U.S. Cl. 210/725

(57) ABSTRACT

A process is provided to reduce phosphorus concentrations in aqueous streams comprising phosphorus. The process comprises (a) adjusting pH, (b) adding a particular metal ion, and (c) adding organic polymers. Optionally anionic inorganic colloids can be added.

### BACKGROUND OF THE INVENTION

1. Field of the Invention

This invention relates to a process to reduce phosphorus concentration in aqueous streams comprising phosphorus, especially streams containing biological materials.

2. Description of the Related Art

The presence of phosphorus in aqueous waste streams in ubiquitous. Sources of environmental phosphorus include detergents, fertilizers and animal wastes. The presence of phosphorus such as, for example, phosphates in waste streams, especially those which empty into lakes, ponds, and the like is an environmental problem. While by itself, phosphate is not harmful, when discharged to a stagnant water system, excess phosphate results in algae growth in surface waters. Biodegradation of the algae causes oxygen depletion in lower water layers, which in turn reduces overall water quality. This is referred to as eutrophication, which is a process by which a body of water becomes rich in dissolved nutrients. Results include loss of potential drinking water or damage to fishing interests.

Phosphorus present in aqueous streams derived from animal processing operations raises other concerns. For example, often operations want to recover the animal by-products in the stream for use as a nutrient source or feed additive. It is vitally important in such operations to avoid addition of reagents that may be harmful if ingested, or increases degradation of the recovered product.

Because phosphorus has value as a potential nutrient (for example, in fertilizer and animal feed), in addition to a desire to prevent environmental problems, there is a desire to recover phosphorus from waste streams for use as a nutrient. Processes that remove phosphorus from streams have often relied on use of iron and aluminum salts to combine with the phosphorus to form a flocculated mass. Although these salts can be effective to remove phosphorus, each of these creates issues for subsequent use of the recovered phosphorus-containing flocculated mass. When excess iron is present in a flocculated mass containing biosolids, the mass has an increased tendency to become rancid over short periods of time, thus limiting use as an additive in a fertilizer or potential animal feed. Aluminum salts at levels greater than 100 ppm cannot be used to remove phosphorus if the intended use of the flocculated mass might result in consumption by animals because aluminum is a neuro-toxin. Therefore it is desired to have an improved process for removal of phosphorus from waste streams, to provide a product that only slowly degrades and does not result in ill-effects upon ingestion.

An advantage of the present invention provides a process that both minimizes risk of environmental problems, and, when the stream is derived from food processing, raises value of recovered phosphorus for subsequent use as a nutrient source. Another advantage is that phosphorus can be removed from an aqueous stream along with other materials present in the stream such as suspended solids and soluble materials by flocculation.

### SUMMARY OF THE INVENTION

The present invention provides in a first embodiment, a process to remove phosphorus from an aqueous stream, which comprises phosphorus, comprising or consisting essentially of:

(a) adjusting pH of the stream to a pH of at least 7 by adding a calcium-containing compound;

(b) adding one or more metal ions selected from the group consisting of zinc ions and manganese ions to the stream;

(c) adding an anionic inorganic colloid to the stream; and

(d) adding a flocculant to produce a flocculated mass.

In a modification of the first embodiment, the present invention provides a process to remove phosphorus from an aqueous stream, which comprises phosphorus, comprising or consisting essentially of:

(a) adjusting pH of the stream to a pH of at least 7 by adding a calcium-containing compound;

(b) adding one or more metal ions selected from the group consisting of zinc ions and manganese ions to the stream;

(c) adding at least one cationic organic polymer to the stream; and

(d) adding at least one anionic organic polymer to the stream to produce a flocculated mass.

The aqueous stream, which comprises phosphorus, is optionally derived from food processing. For such a stream, the process of the first embodiment or modified first embodiment may further comprise recovering the flocculated mass, and using the recovered flocculated mass as a nutrient source.

The process of this invention can also include additional steps such as a second pH adjustment if the first pH adjustment by the addition of the calcium-containing compound was to a pH greater than or equal to pH 10, with a suitable acid to reduce pH to a pH of about 7 to 9. An anionic inorganic colloid can optionally be added if not specified.

In a second embodiment of the present invention, there is provided a process to remove phosphorus from an aqueous stream, which comprises phosphorus, comprising or consisting essentially of:

(a) adding one or more metal ions selected from the group consisting of titanium and zirconium to the stream; and

(b) adding a flocculant to produce a flocculated mass.

As needed, in the second embodiment, the pH of the stream is adjusted to a pH less than 7. Optionally an anionic inorganic colloid is added to the stream, preferably before the flocculent.

When the stream, which comprises phosphorus, is optionally derived from food processing, there is further provided a process to provide a phosphorus-containing nutrient source wherein the second embodiment further comprises recovering the flocculated mass as solids; and using the recovered flocculated mass as a nutrient source or animal feed.

### DETAILED DESCRIPTION

The term “phosphorus” used herein refers to any phosphorus-containing compounds such as, for example, phosphates and phosphoric acid. The term “nutrient source” is used to refers to an additive for animal feed, fertilizer, or both.

As used herein, flocculation means separation of phosphorus and other materials from the stream to be treated wherein the phosphorus and other materials become aggregated and separate from the stream. Flocculation produces a flocculated mass, which can be physically separated from the stream. It is desirable to maximize the size of the flocculated mass in order to facilitate removal of this material from the stream.

Components used in the present invention to remove phosphorus include a component to adjust pH, which is optional when the metal ion is titanium or zirconium, one or more metal ions, one or more flocculants and optionally, anionic inorganic colloids.

Materials

Aqueous Stream

The aqueous stream to be treated by the process of this invention can be from any processing operation, which produces a aqueous stream, which comprises phosphorus. The aqueous stream can be derived from commercial/industrial operations, such as food processing or manufacturing operations, or from municipal water treatment operations or domestic wastewater. The aqueous stream can contain suspended solids, soluble components, or dispersed materials such as, for example, fat and oil. These can be removed from the stream with the phosphorus in the process of this invention.

Food processing operations that produce aqueous streams, which comprise phosphorus, include animal slaughterhouses and animal processing plants, such as those for cattle, hogs, poultry and seafood. Other food processing operations include processing plants for vegetables, grain and dairy food processing. Food processing operations may have non-food uses. Phosphorus content of out-going streams from any of the aforementioned processing operations is regulated and a maximum phosphorus concentration is often imposed.

A particular use of the present invention is realized when the aqueous stream is derived from food processing, especially animal processing. Phosphorus is removed by flocculation, recovered and used as a nutrient source or animal feed. Animal processing operations amenable to this process include, for example, animal slaughterhouses and animal processing plants. Animal slaughterhouses and processing plants include those for cattle, hogs, poultry and seafood. The present invention is especially useful for treating streams comprising phosphorus derived from poultry processing.

pH Adjustment

The pH of an aqueous stream comprising phosphorus is typically above pH 3, more typically above pH 6. In the first embodiment and modified first embodiment of the present invention, the pH of the stream is raised to pH of at least 7 using a calcium-containing compound. Examples of appropriate compounds include all forms of lime, CaO and Ca(OH)₂, both of which are inexpensive and readily available. Addition of calcium to raise pH is used in combination with ions of zinc and manganese to remove phosphorus from the aqueous stream.

In the second embodiment of this invention, the pH of an aqueous stream comprising phosphorus is reduced to less than or equal to pH 7 as needed. In this embodiment any acid or other reagent that can effectively reduce pH to less than or equal to pH 7 can be used. Mineral acids such as sulfuric acid, hydrochloric acid and nitric acid are preferred. Other useful acids or reagents to reduce pH to less than or equal to 7 include, but are not limited to, carbon dioxide, sulfonic acids, and organic acids such as carboxylic acids, acrylic acids, acidic anionic inorganic colloids, partially neutralized acids in which one or more protons are replaced with a metal or ammonium ion, and mixtures thereof. Acidic anionic inorganic colloids include, but are not limited to, low molecular weight polysilicic acid, high molecular weight polysilicic acid microgels, acidic polyaluminosilicates, acid stabilized polysilicate microgels, and mixtures thereof. Examples of acid stabilized polysilicate microgels are described in U.S. Pat. Nos. 5,127,994 and 5,626,721. Acidic metal salts can also be used to reduce pH to less than or equal to pH 7. When the product is to be recovered for use as a nutrient source, there may be restrictions on the acid so as not to affect health upon ingestion. Addition of an acid to lower pH is used in combination with ions of zirconium and titanium to remove phosphorus from the aqueous stream, if needed or desired.

Metal Ions

In the process of this invention, pH adjustment is combined with addition of particular metals ions, flocculant(s) and optionally anionic inorganic colloids to remove phosphorus from aqueous streams. The metal ions useful in this invention are selected for their ability to remove phosphorus from an aqueous stream at a particular range of pH. The metal ions are selected from the group consisting of ions of zinc, manganese, titanium and zirconium. Surprisingly, use of these metal ions results in slow degradation of the phosphorus-containing solids removed and recovered from the stream. A slow degradation rate is especially important when the aqueous stream is derived from food processing operations, where the recovered flocculated mass is used as a nutrient source. The metal ions also have a low toxicity to animals and humans. Zinc and manganese are nutrients themselves, which can be added to animal feed. Titanium and zirconium are in inert forms.

Zinc and manganese perform at alkaline pH to remove phosphorus from aqueous streams and are used in combination with calcium-containing compounds, which raise pH of the stream to greater than or equal to pH 7. Titanium and zirconium perform at acidic pH to remove phosphorus and are used in combination with an acid, if needed, to lower the pH of the stream to less than or equal to pH 7.

Examples of suitable zinc compounds to provide zinc ions include, but are not limited to, zinc chloride, zinc bromide, zinc sulfate, zinc nitrate, zinc alkoxide, and mixtures thereof. Examples of suitable manganese compounds to provide manganese ions include, but are not limited to, manganese chloride, manganese bromide, manganese sulfate, manganese nitrate, and mixtures thereof. Examples of suitable titanium compounds to provide titanium ions include, but are not limited to, titanium chloride, titanium bromide, titanium sulfate, titanium nitrate, titanium alkoxides, and mixtures thereof. Examples of suitable zirconium compounds to provide zirconium ions include, but are not limited to, zirconium chloride, zirconium bromide, zirconium sulfate, zirconium nitrate, zirconium alkoxides, and mixtures thereof. Preferably the chloride or sulfate salts of the metals are used due to low cost, capability, efficacy, and low toxicity The metal ion is used in an effective amount to remove phosphorus from the aqueous stream in combination with pH adjustment and flocculent to produce a flocculated mass. An effective amount can be determined by means available and known to those skilled in the art, using techniques such as colloidal titration. Generally this amount can be in the range of from about 0.01 to about 10,000 ppm, based on solution weight of the stream. Preferably the effective amount of metal ion ranges from about 0.2 to 5000 ppm based on the solution weight of the aqueous stream. The more preferred range is from about 1 to 2500 ppm.

Flocculant

The flocculent can be one or more organic polymers, synthetic or natural, which include cationic polymers, anionic polymers, and amphoteric polymers. Low or high molecular weight organic polymers, or mixtures thereof can be used.

High molecular weight cationic organic polymers will typically have a number average molecular weight greater than 1,000,000. These polymers include natural polymers such as cationic starch, cationic guar gum, and chitosan and high molecular weight synthetic cationic polymers such as cationic polyacrylamide. Cationic starches include those formed by reacting starch with a tertiary or quaternary amine to provide cationic products with a degree of substitution of from 0.01 to 1.0, containing from about 0.01 to 1.0 wt % nitrogen. Suitable starches include potato, corn, waxy maize, wheat, rice and oat.

Useful low molecular weight cationic polymers have a number average molecular weight in the range between about 2,000 to about 1,000,000, preferably between 10,000 and 500,000. The low molecular weight polymer can be for example, polyethylene imine, polyamines, polycyandiamide formaldehyde polymers, diallyl dimethyl ammonium chloride polymers, diallylaminoalkyl (meth)acrylate polymers and dialkylaminoalkyl (meth)acrylamide polymers, a copolymer of acrylamide and diallyl dimethyl ammonium chloride, a copolymer of acrylamide and diallylaminoalkyl (meth)acrylates, a copolymer of acrylamide and dialkyldiaminoalkyl (meth)acrylamides, a polymer of dimethylamine and epichlorohydrin, and mixtures thereof. These have been described in U.S. Pat. Nos. 4,795,531 and 5,126,014.

Amphoteric polymers useful in this invention include natural amphoteric polymers such as starch and guar gum and synthetic amphoteric high molecular weight organic polymers.

Anionic polymers that can be used in the process of this invention have a number average molecular weight of at least 500,000 and a degree of anionic substitution of at least 1 mole %. Anionic polymers with number average molecular weights of greater than 1,000,000 are preferred. Preferably the degree of anionic substitution is 10-70 mole %. Examples of useful synthetic anionic polymers include water soluble vinylic polymers containing acrylamide, acrylic acid, acrylamido-2-methylpropylsulfonate and/or mixtures thereof, and can also be either hydrolyzed acrylamide polymers or copolymers of acrylamide and homologues, such as methacrylamide, with acrylic acid or a homolog, such as methacrylic acid, or even with monomers such as maleic acid, itaconic acid, vinyl sulfonic acid, acrylamido-2-methylpropylsulfonate, and other sulfonate containing monomers. Anionic polymers are further described in U.S. Pat. Nos. 4,643,801; 4,795,531; and 5,126,014. Other anionic polymers that can be used include natural anionic polymers such as anionic starch and anionic guar gum and synthetic anionic polyvinyl acetate.

Selection of appropriate flocculant, including whether cationic or anionic or amphoteric, natural or synthetic, and molecular weight of the flocculent depends on the composition of the aqueous stream to be treated, components in the stream in addition to the phosphorus that are desired to be removed and the other reagents added to remove the phosphorus. Such selections can be readily determined by one skilled in the art. For example, when the stream comprises biosolids, the preferred flocculant is a cationic organic polymer. Alternatively, when the stream comprises suspended ore particles, the preferred flocculant is an anionic organic polymer. Cationic polymers are often beneficially added when an anionic inorganic colloid is added. A combination of anionic polymers and cationic polymers can be advantageously added in the absence of an anionic inorganic colloid.

The organic polymers are used in an effective amount to remove phosphorus from the aqueous stream in combination with pH adjustment and metal ion to produce a flocculated mass. An effective amount can be determined by means available and known to those skilled in the art, using techniques such as colloidal titration. Generally this amount can be in the range of from about 0.01 to about 10,000 ppm of polymer, based on solution weight of the stream. Preferably the effective amount of flocculant ranges from about 0.2 to 5000 ppm based on the solution weight of the aqueous stream. The more preferred range is from about 1 to 2500 ppm.

Anionic Inorganic Colloid

Anionic inorganic colloids can be used in the process of this invention. These include silica-based and non-silica-based anionic inorganic colloids and mixtures thereof. Silica-based anionic inorganic colloids include, but are not limited to, colloidal silica, aluminum-modified colloidal silica, polysilicate microgels, polyaluminosilicate microgels, polysilicic acid, and polysilicic acid microgels, and mixtures thereof. Non-silica-based anionic inorganic colloids include, but are not limited to, clays, especially colloidal bentonite clay. Other non-silica-based anionic inorganic colloids include colloidal tin and titanyl sulfate.

The anionic inorganic colloids used in this invention can be in the form of a colloidal silica sol containing about 2 to 60% by weight of SiO₂, preferably about 4 to 30% by weight of SiO₂. The colloids can have particles with at least a surface layer of aluminum silicate or it can be an aluminum modified silica sol. The colloidal silica particles in the sols commonly have a specific surface area of 50-1000 m²/g, more preferably about 200-1000 m²/g, and most preferably a specific surface area of about 300-700 m²/g. The silica sol can be stabilized with alkali in a molar ratio of SiO₂:M₂O of from 10:1 to 300:1, preferably 15:1 to 100:1 (M is Na, K, Li, and NH₄). The colloidal particles have a particle size of less than 60 nm, with an average particle size less than 20 nm, and most preferably with an average particle size of from about 1 nm to 10 nm.

Microgels are distinct from colloidal silica in that the microgel particles usually have surface areas of 1000 m²/g or higher and the microgels are comprised of small 1-2 nm diameter silica particles linked together into chains and three-dimensional networks. Microgels can be produced by the process disclosed in U.S. Pat. No. 6,060,523, disclosure of which is incorporated herein by reference. Polysilicate microgels, also known as active silicas, have SiO₂:Na₂O ratios of 4:1 to about 25:1, and are discussed on pages 174-176 and 225-234 of “The Chemistry of Silica” by Ralph K. Iler, published by John Wiley and Sons, N. Y., 1979. Polysilicic acid generally refers to those silicic acids that have been formed and partially polymerized in the pH range 1-4 and comprise silica particles generally smaller than 4 nm diameter, which thereafter polymerize into chains and three-dimensional networks. Polysilicic acid can be prepared in accordance with the methods disclosed in U.S. Pat. No. 5,127,994 and 5,626,721, incorporated herein by reference. Polyaluminosilicates are polysilicate or polysilicic acid microgels in which aluminum has been incorporated within the particles, on the surface of the particles, or both. Polysilicate microgels, polyaluminosilicate microgels and polysilicic acid can be prepared and stabilized at acidic pH. Better results have been generally found to occur with larger microgel sizes; generally greater than 10 nm size microgels give the best performance. Microgel size can be increased by any of the known methods such as aging of the microgel, changing pH, changing concentrations, or other methods, known to those skilled in the art.

The polysilicate microgels and polyaluminosilicate microgels useful in this invention are commonly formed by the activation of an alkali metal silicate under conditions described in U.S. Pat. Nos. 4,954,220 and 4,927,498, incorporated herein by reference. However, other methods can also be employed. For example, polyaluminosilicates can be formed by the acidification of silicate with mineral acids containing dissolved aluminum salts as described in U.S. Pat. No. 5,482,693, incorporated herein by reference. Alumina/silica microgels can be formed by the acidification of silicate with an excess of alum, as described in U.S. Pat. No. 2,234,285, incorporated herein by reference.

In addition to conventional silica sols and silica microgels, silica sols such as those described in European patents EP 491879 and EP 502089, incorporated herein by reference, can also be used for the anionic inorganic colloid in this invention. These are commonly referred to as low “S value” sols. EP 491879 discloses a silica sol having an S value in the range of 8 to 45% wherein the silica particles have a specific surface area of 750 to 1000 m²/g, which have been surface-modified with 2 to 25% alumina. EP 502089 discloses a silica sol having a molar ratio of SiO₂ to M₂O, wherein M is an alkali metal ion and/or an ammonium ion of 6:1 to 12:1 and containing silica particles having a specific surface area of 700 to 1200 m²/g.

The anionic inorganic colloids when used, are used in an effective amount, together with a flocculant, to produce a flocculate mass. Preferably an anionic inorganic colloid is used in combination with the flocculant because the addition of the anionic inorganic colloid helps reduce chemical oxygen demand (COD) of the aqueous stream and improves flocculation. An effective amount can range from about 1 to 7500 parts per million (ppm) by weight as solids, e. g., as SiO₂, based on the solution weight of the aqueous stream. The preferred range is from about 1 to 5000 ppm, depending on the anionic inorganic colloid. Preferred ranges for selected anionic inorganic colloids are 2 to 500 ppm for polysilicic acid or polysilicate microgels; 4 to 1000 ppm for colloidal silica, and 2 to 2000 ppm for inorganic colloidal clays, such as bentonite.

Process

The process results in agglomeration of the phosphorus along with other components of the stream into a flocculated mass, which can be separated from the aqueous stream and recovered.

The process of this invention involves treatment of an aqueous stream, which comprises phosphorus, to reduce the concentration of phosphorus in the stream by flocculation and optionally to separate the flocculated mass. This mass can be recovered for subsequent use. This process is effective for removal of not only phosphorus, but also for removal of suspended solids, dispersed materials, and certain soluble materials, such as soluble biomaterials, in the aqueous stream. Furthermore, when an anionic inorganic colloid is added, COD is also effectively reduced.

The process of this invention involves treating an aqueous stream comprising phosphorus by adjusting pH of the stream as needed. In the first embodiment and modified first embodiment of this invention, pH is adjusted to a pH of at least 7 using a calcium compound. In these embodiments, a metal ion selected from the group consisting of zinc and manganese ions is added. Preferably, when zinc or manganese is used, pH is adjusted to a pH of at least pH 9, more preferably to a pH between 9 and 11. Optionally, if pH is adjusted to pH of at least 10, the pH may be lowered to a pH of 7 to 9, using any convenient acid, such as those listed hereinabove, preferably a mineral acid such as sulfuric acid. This second pH adjustment is performed after the first pH adjustment, and can also occur after addition of the other components and optional components. A two step adjustment of pH helps to reduce COD.

In a second embodiment of the present invention, pH of the aqueous stream comprising phosphorus is adjusted, as needed, to a pH less than or equal to pH 7 using an acid. This step can be omitted if the initial pH of the stream is below 7. In these embodiments, a metal ion selected from the group consisting of titanium ions, zirconium ions, and combinations thereof is added to the stream. Preferably when titanium or zirconium is used, the pH of the stream is adjusted to a pH less than or equal to pH 6, more preferably to a pH between 3 and 5, inclusive.

The process of this invention further involves addition of a flocculant to the aqueous stream. As described above, the flocculant is an organic polymer, which can be cationic, anionic or amphoteric. The organic polymer can be a high or low molecular weight polymer. Generally preferred are high molecular weight organic polymers, especially synthetic polymers such as polyacrylamide, due to availability and performance.

In the first and optionally second embodiments of this invention, an anionic inorganic colloid is added to the aqueous stream. In the modified first embodiment, the flocculant is a combination of a cationic and an anionic organic polymer. In the second embodiment, the flocculant can be a cationic, anionic, amphoteric organic polymer or mixtures thereof.

Optional components which can be added to the process of this invention include anionic inorganic colloids, and additional organic polymers, such as those described above as flocculants. Adjustment of pH, addition of metal ion, flocculant and optional components, effectively removes phosphorus from the aqueous stream by flocculation to produce a flocculated mass comprising phosphorus. Other components of the aqueous stream, which comprises phosphorus, such as suspended solids and certain dissolved or dispersed materials, may also be removed and contained in the mass.

Generally, the steps can be conducted in any sequence or simultaneously. The term “adding” can have the conventional interpretation of introducing a material into the aqueous stream and can also include any means of contacting the aqueous stream with the ions, polymers, and other components added in the process of this invention. Preferably, the flocculent is added after the other components, including optional components. Here, flocculant can mean one or more organic polymers as described above. Most typically, the first step is adjustment of pH, especially when pH of the stream is first adjusted to a pH of at least 10, and subsequently adjusted to a pH of 7-9. Addition of metal ion, anionic inorganic colloid, when used, are typically added after pH adjustment, but can be added prior to pH adjustment with no detrimental effect on the process. For efficiency purposes, it is preferred to perform the steps in succession, with minimal time between steps. However, longer reaction times between steps are not detrimental to the process and not precluded from the scope of this invention.

The flocculated mass containing phosphorus can optionally be separated from the treated stream by conventional separation processes such as sedimentation, flotation, filtering, centrifugation, decantation, or combinations of such processes. The separated mass can be recovered as solids. In particular, when the stream is derived from food processing the recovered solids can be used as a nutrient source.

### EXAMPLES

### Example 1

### Effect of pH on Zinc Removal of Phosphorus

Wastewater stream with a pH of 6.4 was obtained from a poultry processing plant. Soluble phosphorus content of the wastewater was determined to be 10.9 by filtering through Whattman 934 AH filter paper and measuring the phosphorus concentration of the filtrate using Hach method 8190 (based on an adaptation of USEPA Method 365.2 and Standard Method 4500-P B, 5 and P.E). Wastewater pH was adjusted with saturated lime solution to the values shown in Table 1. Calcium as CaCl₂ was added as necessary to maintain a relatively constant Ca content of about 400 ppm. Silica, 160 ppm, as Particlear® MX (available from E.I. du Pont de Nemours & Company, Wilmington, Del.) was added followed by addition of 15 ppm Zn as ZnCl₂. Cationic polyacrylamide, Hyperfloc CP913 HN (available from Hychem, Inc., Tampa, Fla.), 10 ppm was added followed by addition of 4 ppm anionic polyacrylamide, Magnifloc 135 (available from Cytek, West Paterson, N.J.). All additions were made 15 seconds apart. The flocculated masses were removed by filtration and the filtrate phosphorus concentration was measured using Hach method 8190.

TABLE 1

| Adjusted pH | Final pH | Phosphorus, ppm |
|---|---|---|
| 8.2 | 7.4 | 9.0 |
| 8.7 | 7.6 | 8.2 |
| 9.2 | 8.5 | 5.8 |
| 10 | 9.4 | 4.4 |

As can be seen from Table 1, use of zinc salt in combination with lime to adjust pH, silica microgel and organic polymers, reduces phosphorus concentrations. More effective reduction is at pH greater than 9, which corresponds to a higher final pH.

### Example 2

### Effect of Zinc Dose

Wastewater with a pH of less than 7 was obtained from a poultry processing plant. Soluble phosphorus content of the wastewater was 10.5, determined as described in Example 1. The pH of the wastewater was adjusted with saturated lime solution to pH 11 and then to pH 9 with sulfuric acid. Silica, 80 ppm as Particlear® MX was added followed by various dosages of ZnCl₂. Cationic polyacrylamide, Percol 7650 (available from Ciba Specialty Chemicals, Basel, Switzerland), 10 ppm was then added. All additions were made 15 seconds apart. The flocculated mass was removed by filtration and the phosphorus concentration of the filtrate was measured using Hach method 8190.

TABLE 2

| Zinc, ppm | Final pH | Phosphorus, ppm |
|---|---|---|
| 50 | 7.5 | 1.9 |
| 25 | 8.2 | 3.3 |
| 12 | 8.3 | 5.3 |

As can be seen from Table 2, at higher doses of zinc, more phosphorus is removed from the waste stream.

### Example 3

### Advantage of Calcium to Adjust pH

Wastewater having a pH of 6.2 was obtained from a poultry processing plant. The phosphorus concentration was greater than 10, determined according to the method described in Example 1. Wastewater was adjusted with either saturated lime solution or NaOH to the pH values shown in “First pH Adjustment” in Table 3. The pH was then adjusted with sulfuric acid to pH 9. Zinc, 50 ppm, as ZnCl₂, was added followed by 80 ppm of SiO₂ as Particlear® MX and 10 ppm of Percol 7650, cationic polyacrylamide. All additions were made 15 seconds apart. The flocculated masses were allowed to settle. The clarified water was then sampled and phosphorus concentration determined using Hach method 8190.

TABLE 3

| Base | First pH Adjustment | Final pH | Phosphorus, ppm |
|---|---|---|---|
| CaO | 9 | 7.9 | 3.1 |
| NaOH | 9 | 7.3 | 6.2 |
| CaO | 10 | 7.4 | 3.8 |
| NaOH | 10 | 7.5 | 5.2 |
| CaO | 11 | 7.4 | 2.5 |
| NaOH | 11 | 7.3 | 5.2 |

As can be from Table 3, use of calcium to adjust pH is significantly more effective than use of sodium for reducing phosphorus concentration in combination with zinc ions, silica microgel.

### Example 4

### Effect of Addition Order

Wastewater having a pH of 6.6 was obtained from a poultry processing plant. Soluble phosphorus content of the wastewater was 12.2 ppm, determined as described in Example 1. The wastewater pH was adjusted to pH 9 with saturated CaO solution. Zinc, 10 ppm, as ZnCl₂ was added. Silica, 80 ppm as Particlear® MX was added. Cationic polyacrylamide, Percol 7650, 10 ppm and 4 ppm of anionic polyacrylamide Magnifloc 135 were then added. Order of pH adjustment and chemical addition were varied as shown in Table 4.

TABLE 4

| Order of Addition | Final pH | Phosphorus, ppm |
|---|---|---|
| CaO, SiO₂, Zn, Apam⁽¹⁾, Cpam⁽²⁾ | 9.4 | 5.1 |
| SiO₂, CaO, Zn, Apam, Cpam | 9.1 | 3.2 |
| Zn, CaO, SiO₂, Apam, Cpam | 9.0 | 5.4 |
| CaO, Zn, SiO₂, Apam, Cpam | 8.8 | 3.8 |

⁽¹⁾Apam = anionic polyacrylamide.
⁽²⁾Cpam = cationic polyacrylamide

As can be seen from Table 4, the process can be operated at different orders of additions of reagents and still effectively reduce phosphorus concentrations.

Example 5

### Reduction of Phosphorus in the Absence of Inorganic Colloid

Wastewater having a pH of 6.4 was obtained from a poultry processing plant. Soluble phosphorus content of the wastewater was 6.9, determined as described in Example 1. Various amounts of ZnCl₂ were added to the wastewater. The wastewater pH was then adjusted with saturated lime solution to pH 9. Cationic polyamine, Agefloc A50HV (available from Ciba Specialty Chemicals, Basel, Switzerland), 40 ppm, was added followed by 10 ppm of cationic polyacrylamide Percol 7650. Additions were made 15 seconds apart. Solids were allowed to settle for 2 minutes, then COD and phosphorus content of the treated wastewater were measured. Phosphorus concentrations of the filtrate phosphorus concentrations were measured using Hach method 8190. COD was determined using a Hach COD Test Kit, available from the Hach Company, Loveland, Colo.

Anionic polyacrylamide Magnifloc 135, 4 ppm, was then added. Solids were allowed to settle for a second time and COD and phosphorus content were measured.

TABLE 5

| | | | | Cationic and Anionic | |
|---|---|---|---|---|---|
| Zinc, | | Cationic Polymer Only | | Polymer | |
| ppm | Final pH | COD | Phosphorus, ppm | COD | Phosphorus, ppm |
| 10 | 9.0 | 1312 | 5.8 | 511 | 2.8 |
| 20 | 9.1 | 1321 | 2.8 | 316 | 2.1 |
| 30 | 9.2 | 1322 | 2.8 | 293 | 1.2 |

As can be seen from Table 5, while there is some reduction in phosphorus concentration and COD in waste streams using a zinc salt, lime, and cationic polymers, in the absence of an anionic inorganic colloid, improved results are achieved when a combination of cationic and anionic polymers is used. Higher zinc doses increase reduction in phosphorus concentrations.

### Example 6

### Reduction of Phosphorus Concentrations from Non-biological Sources

Sodium phosphate was added to a wastewater of pH 6.7 obtained from a poultry processing plant to simulate phosphorus in streams derived from meat marinade solutions. Wastewater phosphorus concentration was increased from 9.3 to 18.3 ppm as measured using Hach method 8190. The wastewater pH was adjusted to pH 11 with saturated lime solution. Zinc, 10 ppm, as ZnCl₂ was added. The pH was adjusted to the values shown with sulfuric acid. Silica, 80 ppm, as Particlear® MX was added followed by 10 ppm of cationic polyacrylamide Percol 7650 followed by 4 ppm of anionic polyacrylamide Magnifloc 135. All additions were made 15 seconds apart. The flocculated masses were removed by filtration and the phosphorus concentrations of the filtrates were measured using Hach method 8190.

TABLE 6

| H₂SO₄-adjusted pH | Final pH | Phosphorus, ppm |
|---|---|---|
| 9 | 7.9 | 7.5 |
| 8.5 | 7.5 | 9.9 |
| 8 | 7.0 | 11.7 |
| 7.5 | 5.8 | 15.9 |
| 7.0 | 4.2 | 16.3 |
| 6.0 | 3.1 | 15.7 |

As can be seen from Table 6, pH impacts the reduction of phosphorus from the wastewater containing added phosphorus. In addition, it appears that one mole of zinc can effectively remove about one mole of phosphorus so long as the final pH is greater than 7. At a final pH of 7, the removal of phosphorus by zinc is less efficient and at a final pH less than 7, there is no significant removal of phosphorus.

### Example 7

### Comparison of Mn and Zn to Reduce Phosphorus Concentration

Wastewater having a pH 6.6 was obtained from a poultry processing plant. Phosphorus concentration was 12.2 ppm as determined according to Example 1. Wastewater pH was adjusted with saturated lime solution to pH 9. Silica, 80 ppm, as Particlear® MX was added followed by 10 ppm of Mn as MnSO₄ or 10 ppm Zn as ZnCl₂. Cationic polyacrylamide, Percol 7650, 10 ppm, was added followed by 4 ppm of anionic polyacrylamide Magnifloc 135. All additions were made 15 seconds apart. The flocculated masses were removed by filtration and the phosphorus concentration of the filtrate was measured using Hach method 8190.

TABLE 7

| Metal ion added | Final pH | Phosphorus, ppm |
|---|---|---|
| Mn | 9.0 | 3.3 |
| Zn | 9.0 | 3.8 |

As can be seen from Table 7, manganese and zinc are both effective at reducing phosphorus concentration in aqueous streams.

### Example 8

### Effect of pH and Mn Concentration on Reducing Phosphorus Concentration

Wastewater having a pH of 6.2 was obtained from a poultry processing plant. Phosphorus concentration was 10.5 ppm according to Example 1. Wastewater pH was adjusted to pH 2 with sulfuric acid then to pH 8 with saturated lime solution. The final pH depended on both the amount of MnSO₄ added and the amount of lime added. MnSO₄ is acidic and reduces pH, while the lime was partially insoluble and continued to dissolve, which created difficulty in accurately reaching and maintaining pH 8. Silica, 80 ppm, as Particlear® MX was added followed by various doses of Mn as MnSO₄. Cationic polyacrylamide Percol 7650, 10 ppm. was then added. All additions were made 15 seconds apart. The flocculated masses were removed by filtration and the phosphorus concentrations of the filtrates were measured using Hach method 8190.

TABLE 8

| Manganese, ppm | Final pH | Phosphorus. ppm |
|---|---|---|
| 40 | 7.6 | 3.8 |
| 20 | 7.4 | 6.5 |
| 30 | 8.2 | 1.6 |
| 20 | 8.7 | 0.7 |

As can be seen from Table 8, reduction of phosphorus is dependent on both final pH and the amount of added manganese. While more manganese results in a greater reduction of phosphorus at comparable pH, even greater phosphorus reduction can be achieved with less manganese at a higher final pH.

### Example 9

### Use of Titanium Salts to Reduce Phosphorus Concentration and COD

A titanium solution was prepared by adding TiCl₄ to cold deionized water to provide a 0.25 weight % Ti solution. Wastewater from a poultry processing plant had a phosphorus concentration of 22 ppm determined according to Example 1 and a COD of 776 ppm. The wastewater was treated by adjusting the pH to 4.8 with sulfuric acid, adding 100 ppm of SiO₂ as Particlear® MX, adding various amounts of Ti, 10 ppm cationic polyacrylamide Percol 7650 and 4 ppm of anionic polyacrylamide ETS-700. All additions were made 15 seconds apart. The flocculated masses were removed by filtration and the phosphorus concentrations of the filtrates were measured using Hach method 8190. COD of the filtrate was measured using Hach method 8000.

The above was repeated except the Ti was added before adjusting the wastewater pH. COD was not measured in these runs.

TABLE 9

| | | | | Ti added before | |
|---|---|---|---|---|---|
| | Ti added after pH adjustment | | | pH adjustment | |
| Titanium, | | Phosphorus, | COD, | | Phosphorus, |
| ppm | Final pH | ppm | ppm | Final pH | ppm |
| 104 | 4.6 | 0.4 | 408 | 4.8 | 0.2 |
| 77 | 4.6 | 0.3 | 402 | 4.8 | 0.4 |
| 51 | 4.7 | 0.4 | 418 | 4.8 | 0.4 |
| 26 | 4.6 | 3.2 | 441 | 4.7 | 4.4 |
| 0 | 4.8 | 11.9 | 511 | | |

As can be seen from Table 9, addition of titanium at pH below 5 is effective to reduce phosphorus concentrations and COD in a waste stream.

### Example 10

### Use of Zirconium Salts to Reduce Phosphorus Concentration and COD

Wastewater from a poultry processing plant had a phosphorus concentration of 15.2 as determined according to Example 1 and a COD of 591 as determined by Hach Method 8000. The wastewater was treated by adjusting the pH to 4.8 with sulfuric acid, adding 100 ppm of SiO₂ as Particlear® MX, adding various amounts of zirconium as Zr(SO₄)₂, 10 ppm cationic polyacrylamide Percol 7650 and 4 ppm of anionic polyacrylamide ETS-700. All additions were made 15 seconds apart. The flocculated masses were removed by filtration and the phosphorus concentrations of the filtrates were measured using Hach method 8190. COD of the filtrate was measured using Hach method 8000.

The above was repeated except the Zr was added before adjusting the wastewater to pH 4.6.

TABLE 10

| | Zr added | | | Zr added | | |
|---|---|---|---|---|---|---|
| | after pH adjustment | | | before pH adjustment | | |
| Zirconium | | Phosphorus | COD | Final | Phosphorus | COD |
| ppm | Final pH | ppm | ppm | pH | ppm | ppm |
| 69 | 4.6 | 0.4 | 506 | 4.7 | 0.5 | 418 |
| 52 | 4.6 | 0.5 | 502 | 4.7 | 0.5 | 492 |
| 35 | 4.7 | 1.0 | 495 | 4.8 | 1.5 | 520 |
| 17 | 4.7 | 8.3 | 543 | 4.8 | 12.4 | 492 |
| 9 | 4.7 | 11.5 | 493 | 4.7 | 10.5 | 567 |
| 0 | 4.8 | 15.2 | 591 | | | |

As can be seen from Table 10, addition of zirconium at pH below 5 is effective to reduce phosphorus concentrations and COD in a waste stream.

### Example 11

### Sludge Degradation Comparison

A first wastewater obtained from an Eastern Shore chicken processing plant had a TSS (total suspended solids) of 1500 ppm and a phosphorus content of 6.2 ppm as determined according to Example 1. A second wastewater obtained from the same chicken processing plant contained 8.1 ppm phosphorus and had a TSS of 1300 ppm. The wastewaters were flocculated by treatments with pH adjustment, addition of metal ion, addition of Particlear® Mx SiO₂ microgel, cationic polyamine, A50HV, cationic polyacrylamide, P-7650 (CPAM), anionic polyacrylamide, Magnifloc 135 (APAM), providing a clarified water as detailed in Table 11.

The flocculated masses were removed from the waters with an aquarium net. The phosphorus concentrations and COD of the clarified waters were measured. The recovered wet solids were dewatered in a pan for about one hour. The drained water was used to adjust solids to the same concentration of water as the sample with the maximum water content as determined by drying a 5 gram sample in an oven at 120° C.

TABLE 11

| | | | | Parti- | | | |
|---|---|---|---|---|---|---|---|
| | Metal | pH | pH | clear ® | Poly- | | |
| | Ion | adjust | adjusted | MX, SiO₂, | amine | CPAM | APAM |
| Run^{a} | (ppm) | to | with | (ppm) | (ppm) | (ppm) | (ppm) |
| A | Zn (20) | 9 | CaO | 80 | 40 | 10 | 4 |
| B | Zn (20) | 9 | CaO | 80 | 40 | 10 | 4 |
| C | Zr (30) | 4.6 | H₂SO₄ | 80 | | 10 | 4 |
| D | Ti (15) | 5.2 | H₂SO₄ | 80 | | 10 | 4 |
| E | Zn (20) | 9.5 | CaO | 80 | 40 | 10 | 4 |
| F | Mn (20) | 4.8 | H₂SO₄ | 80 | 40 | 10 | 4 |

^{a}Runs A, B, and C used first wastewater and runs D, E, and F used second wastewater.

For comparison, a sample of each wastewater was treated at a processing plant using Fe₂(SO₄)₃, 55 ppm Fe, and anionic polyacrylamide 2405, 10 ppm, available from CSC Technologies (Laurel, Md.) (runs G and H). Flocculated masses were produced and recovered from each wastewater. Recovered solids did not dewater further, so moisture contents were not adjusted.

Samples of each recovered solid were placed in capped polyethylene bottles in a 100° F. water bath to simulate storage that could be expected in a tank truck. A portion of the same was removed and tested for free fatty acids (FFA), an indication of degradation, after one day of storage. To determine FFA, 20 grams of a sample were slurried in 100 ml of warm ethanol, which had been neutralized with NaOH to a phenolphthalein indicator end point. The sample was then titrated with 0.25 N NaOH to the same phenolphthalein end point. FFA content, as oleic acid, was reported using the equation:

$$\text{FFA as oleic} = \frac{\text{(ml NaOH)} \text{(N NaOH)} ( 28.2 )}{\text{(weight of the sample)}}$$

The FFA content of the recovered solids from the processing plant for the first wastewater, sample G, was 14 ppm before storage at 100° F. The FFA for the second wastewater was not determined before heating. Results are provided in Table 12.

TABLE 12

| | | | | | FFA, |
|---|---|---|---|---|---|
| Run | Wastewater | Metal Ion | Phosphorus, ppm | Storage pH | ppm |
| A | 1^{St} | Zn | 3 | 4.9 | 24 |
| B | 1^{St} | Zn | 3 | 7.5 | 37 |
| C | 1^{St} | Zr | 1.6 | 4.9 | 27 |
| D | 2^{nd} | Ti | 2.2 | 4.5 | 26 |
| E | 2^{nd} | Zn | 4.1 | 4.9 | 24 |
| F | 2^{nd} | Mn | 2.9 | 9 | 36 |
| G | 1^{St} | Fe | N/A* | “as is” | 53 |
| H | 2^{nd} | Fe | N/A* | “as is” | 100 |

*Data not available.

The pH of samples A and E were adjusted to pH 4.9 prior to storage. There was no adjustment in the pH of the other samples, whereupon the pH of the stored samples was about the same as the final pH of the treated water. By “as is” is meant there was no adjustment of the pH of the simulated stored samples G and H. The specific pH was not available.

As can be seen from Table 12, the processes of this invention to remove phosphorus from the wastewaters showed lower increases in FFA than the plant sample treated with ferric sulfate, indicating less degradation of the recovered solids.

### Example 12

### Comparison of Metal Ions with Metal Oxides

Wastewater with a pH of less than 7 was obtained from a poultry processing plant. Soluble phosphorus content of the wastewater was 10.3 ppm, determined as described in Example 1. The pH of the wastewater was adjusted with saturated lime solution to pH 9 with sulfuric acid. A metal source was added to the wastewater as specified in Table 13. After 15 seconds of mixing, 40 ppm of a polyamine, Agefloc A50HV, was added to the wastewater and mixed for 40 seconds, followed by 10 ppm of a cationic polyacrylamide (Percol® 7650) with mixing for 30 seconds and then 4 ppm of an anionic polyacrylamide (Magnifloc® 135) with mixing for 30 seconds, when mixing was stopped. The resulting flocculated mass was removed by filtration and the phosphorus concentration of the filtrate was measured using Hach method 8190.

TABLE 13

| Metal source, ppm | Metal, ppm | Final pH | Phosphorus, ppm |
|---|---|---|---|
| ZnCl₂ | 10 | 9.2 | 1.7 |
| ZnCl₂ | 20 | 9.4 | 1.7 |
| ZnCl₂ | 30 | 9.5 | 1.5 |
| ZnO | 10 | 9.2 | 6.9 |
| ZnO | 20 | 9.2 | 7.1 |
| ZnO | 30 | 9.2 | 6.1 |
| MnSO₄.H₂O | 10 | 9.1 | 1.6 |
| MnSO₄.H₂O | 20 | 9.1 | 1.9 |
| MnSO₄.H₂O | 30 | 9.0 | 1.4 |
| MnO₂ | 10 | 9.3 | 6.9 |
| MnO₂ | 20 | 9.0 | 7.1 |
| MnO₂ | 30 | 9.2 | 6.1 |

As can be seen from Table 13, when the metal salts, ZnCl₂ and MnSO₄.H₂O, are used, which provide soluble metal ions in wastewater, phosphorus removal is significantly enhanced over use of insoluble metal oxides.

What is claimed is:

1. A process to remove phosphorus from an aqueous stream, which comprises phosphorus, comprising: (a) adjusting pH of the stream to a pH of at least 7 by adding a calcium-containing compound; (b) adding one or more metal ions selected from the group consisting of zinc and manganese ions to the stream; (c) adding an anionic inorganic colloid to the stream; and (d) adding a flocculant to produce a flocculated mass.

2. The process of claim 1 wherein the aqueous stream is derived from food processing and the process further comprises recovering the flocculated mass and using the recovered flocculated mass as a nutrient source.

3. The process of claim 1 or 2 wherein the pH of the stream is adjusted to at least 10.

4. The process of claim 3 further comprising lowering the pH to 7 to 9.

5. A process to remove phosphorus from an aqueous streams, which comprises phosphorus, comprising (a) adjusting pH of the stream to a pH of at least 7 by adding a calcium containing compound; (b) adding one or more metal ions selected from the group consisting of zinc ions and manganese ions to the stream; (c) adding at least one cationic organic polymer to the stream; and (d)adding at least one anionic organic polymer to the stream to produce a flocculated mass.

6. The process of claim 5 wherein the aqueous stream is derived from food processing and the process further comprises recovering the flocculated mass and using the recovered flocculated mass as a nutrient source.

7. The process of claim 5 or 6 wherein the cationic polymer is cationic polyacrylamide and wherein the anionic polymer is anionic polyacrylamide.

8. The process of claim 5 or 6 wherein the pH of the stream is adjusted to at least 10.

9. The process of claim 7 wherein the pH of the stream is adjusted to at least 10.

10. The process of claim 5 or 6 further comprising lowering the pH to 7 to 9.

11. The process of claim 7 further comprising adding to the stream an anionic inorganic colloid.

12. The process of claim 8 further comprising adding to the stream an anionic inorganic colloid.

13. The process of claim 9 further comprising adding to the stream an anionic inorganic colloid.

14. The process of claim 10 further comprising adding to the stream an anionic inorganic colloid.

15. A process to remove phosphorus from an aqueous stream, which comprises phosphorus, comprising (a) adding one or more metal ions selected from the group consisting of titanium and zirconium to the stream; and (b) adding a flocculant to the stream to produce a flocculated mass.

16. The process of claim 15 further comprising adjusting the pH of the stream to 7 or lower.

17. The process of claim 15 wherein the aqueous stream is derived from food processing further comprising recovering the flocculated mass and using the recovered flocculated mass as a nutrient source.

18. The process of claim 16 further comprising recovering the flocculated mass and using the recovered flocculated mass as a nutrient source.

19. The process of claim 16 wherein said pH is 3 to 5.

20. The process of claim 17 wherein said pH is 3 to 5.

21. The process of claim 18 wherein said pH is 3 to 5.

22. The process of claim 19, 20, or 21 further comprising adding to the stream an anionic inorganic colloid.

23. The process of claim 1 or 15 wherein the flocculant is an anionic organic polymer.

24. The process according to claims 1 or 15 further comprising separating the flocculated mass from the stream.

25. A process consisting essentially of adjusting the pH of an aqueous stream, which comprises phosphorus, to at least 7 by adding a calcium-containing compound; adding one or more metal ions selected from the group consisting of zinc ions, manganese ions, and mixtures thereof to the stream; and
(a) adding an anionic inorganic colloid and a flocculant to produce a flocculated mass; or
(b) adding at least one cationic organic polymer and at least one anionic organic polymer to the stream to produce a flocculated mass; or
(c) adding a flocculant to the stream to produce a flocculated mass; recovering the flocculated mass; and using the recovered the flocculated mass as a nutrient source.

26. The process of claim 25 consisting essentially of adjusting the pH of an aqueous stream, which comprises phosphorus, to at least 7 by adding a calcium-containing compound; adding one or more metal ions selected from the group consisting of zinc ions, manganese ions, and mixtures thereof to the stream; and adding an anionic inorganic colloid to the stream; and adding a flocculant to produce a flocculated mass.

27. The process of claim 25 consisting essentially adjusting the pH of an aqueous stream, which comprises phosphorus, to at least 7 by adding a calcium-containing compound; adding one or more metal ions selected from the group consisting of zinc ions, manganese ions, and mixtures thereof to the stream; adding at least one cationic organic polymer to the stream; and adding at least one anionic organic polymer to the stream to produce a flocculated mass.

28. The process of claim 25 consisting essentially of adjusting the pH of an aqueous stream, which comprises phosphorus, to at least 7 by adding a calcium-containing compound; adding one or more metal ions selected from the group consisting of zinc ions, manganese ions, and mixtures thereof to the stream; adding a flocculant to the stream to produce a flocculated mass; recovering the flocculated mass; and using the recovered the flocculated mass as a nutrient source or animal feed.

29. The claim of 25, 26, 27, or 28 wherein the pH of the stream is adjusted to at least pH 10.

30. The claim of 25, 26, 27, or 28 wherein the pH of the stream is adjusted to at least 10 and is subsequently lowered to 7 to 9.

31. The process of claim 27 consisting essentially of adjusting the pH of an aqueous stream, which comprises phosphorus, to at least 7 by adding a calcium-containing compound; adding one or more metal ions selected from the group consisting of zinc ions, manganese ions, and mixtures thereof to the stream; adding at least one cationic organic polymer to the stream; adding an anionic inorganic colloid to the stream; and adding at least one anionic organic polymer to the stream to produce a flocculated mass.

32. The process according to claim 28 consisting essentially of adjusting the pH of an aqueous stream, which comprises phosphorus, to at least 7 by adding a calcium-containing compound; adding one or more metal ions selected from the group consisting of zinc ions, manganese ions, and mixtures thereof to the stream; adding an anionic inorganic colloid to the stream; adding a flocculant to the stream to produce a flocculated mass; recovering the flocculated mass; and using the recovered the flocculated mass as a nutrient source or animal feed.

33. The process of claim 27 wherein the cationic polymer is cationic polyacrylamide and wherein the anionic polymer is anionic polyacrylamide.

34. A process to remove phosphorus from an aqueous stream, which comprises phosphorus, consisting essentially of adding one or more metal ions selected from the group consisting of titanium and zirconium, and a flocculant to the stream to the stream to produce a flocculated mass.

35. The process of claim 34 consisting essentially of adjusting the pH of the stream to 7 or lower, and adding one or more metal ions selected from the group consisting of titanium and zirconium and a flocculant to the stream to the stream to produce a flocculated mass; or adjusting the pH of the stream to 7 or lower, adding one or more metal ions selected from the group consisting of titanium and zirconium ions, a flocculent to produce a flocculated mass, recovering the flocculated mass, and using the recovered flocculated mass as a nutrient source.

36. The process of claim 35 consisting essentially of adjusting the pH of the stream to 7 or lower; and adding one or more metal ions selected from the group consisting of titanium and zirconium, and a flocculant to the stream to the stream to produce a flocculated mass.

37. The process of claim 35 consisting essentially of adjusting the pH of the stream to 7 or lower; and adding one or more metal ions selected from the group consisting of titanium and zirconium, and a flocculant to produce a flocculated mass; recovering the flocculated mass; and using the recovered flocculated mass as a nutrient source wherein the aqueous stream is derived from food processing and the process.

38. The process of claim 35 consisting essentially of adjusting the pH of the stream to 7 or lower; and adding one or more metal ions selected from the group consisting of titanium and zirconium, an anionic inorganic colloid, and a flocculant to the stream to the stream to produce a flocculated mass.

39. The process of claim 34 consisting essentially of adjusting the pH of the stream to 7 or lower; adding one or more metal ions selected from the group consisting of titanium ions and zirconium ions, an anionic inorganic colloid, and a flocculent to produce a flocculated mass; recovering the flocculated mass; and using the recovered flocculated mass as a nutrient source wherein the aqueous stream is derived from food processing.

40. The process of 36, 37, 38, or 39 wherein the pH is adjusted to 3-5, inclusive.
